(19) United States
(12) Patent Application Publication
(10) Pub. No.: US 2026/0063825 A1
(43) Pub. Date: Mar. 5, 2026

(54) Method, medium, and device for processing meteorological data based on improved moving average filtering

(71) Applicant: Shanghai Investigation, Design & Research Institute Co., Ltd., Shanghai (CN)

(72) Inventors: Yuxin ZANG, Shanghai (CN); Xuedan ZHU, Shanghai (CN); Zixiang YAN, Shanghai (CN)

(73) Assignee: Shanghai Investigation, Design & Research Institute Co., Ltd., Shanghai (CN)

(21) Appl. No.: 19/313,826

(22) Filed: Aug. 28, 2025

(30) Foreign Application Priority Data
Sep. 5, 2024 (CN) 2024112428470

(51) Int. Cl. G01W 1/00

(52) U.S. Cl. CPC G01W 1/00

(57) ABSTRACT

The present disclosure provides a method, medium, and device for processing meteorological data based on improved moving average filtering. The method includes: collecting and cleaning original meteorological data to obtain to-be-processed meteorological data; performing weighted moving average filtering on the to-be-processed meteorological data to obtain filtered meteorological data; conducting trend analysis and boundary processing on the filtered meteorological data; and reconstructing the filtered meteorological data after being subjected to the trend analysis and boundary processing to ensure the data continuity and integrity. The present disclosure provides higher precision and reliability in the meteorological data processing process.

### FIELD OF TECHNOLOGY

The present disclosure relates to the field of meteorological data technology, and in particular to a method, medium, and device for processing meteorological data based on improved moving average filtering.

### BACKGROUND

Currently, meteorological data filtering is often performed using band-pass filtering techniques, such as Lanczos filtering. Lanczos filtering is a commonly used resampling and signal processing technique, widely applied in meteorological data processing due to its excellent frequency domain characteristics. However, despite its relatively superior performance, Lanczos filtering still faces several significant issues when processing meteorological data:

1. Boundary issue: When applying Lanczos filtering, the filter is unable to fully cover all data points at the beginning and end of the data sequence, resulting in ineffective filtering of the data at the boundaries. This boundary effect can result in data loss or inaccurate processing, particularly when handling meteorological data of limited length. Additionally, due to the lack of sufficient neighboring data points around the boundary data points for interpolation, the weight distribution of the filter cannot uniformly cover all data points, leading to an increase in interpolation errors at the boundaries. These errors introduce significant uncertainty in high-precision meteorological data processing, such as short-term weather forecasting.

2. Edge effect: The Lanczos filter is based on the weighted sum of sinc functions. The data near the edges is influenced by the filter kernel function, which can easily lead to ringing artifacts. The ringing artifacts cause unnatural fluctuations near the edges, distorting the true characteristics of meteorological data and affecting its interpretation and application. Due to the presence of the edge effect, the filtered data may exhibit localized signal distortion. This distortion is especially noticeable when processing meteorological data with abrupt changes (e.g., sudden changes in wind speed or precipitation), potentially leading to the loss or misinterpretation of critical meteorological information.

3. Frequency domain characteristic limitations: Although Lanczos filtering exhibits good low-pass filtering properties, its effectiveness in handling high-frequency noise remains limited. In meteorological data, high-frequency noise is typically caused by sensor errors or environmental interference. If not properly addressed, it can affect the accuracy of subsequent data analysis and predictive models. The frequency response function of the Lanczos filter has a specific bandwidth limitation, making it unable to adapt flexibly to meteorological data with various frequency components. This limitation becomes evident when processing complex meteorological data with multiple coexisting frequency components (such as radar reflectivity data), where certain frequency components may not be effectively filtered, compromising the comprehensiveness and accuracy of the data.

4. Computational complexity: Lanczos filtering requires the calculation of a large number of weighted sums. When processing large-scale meteorological data (such as high-resolution satellite imagery or long-term meteorological measurement data), its computational complexity is relatively high, making it difficult to meet real-time processing demands. This can lead to processing delays in high-frequency updating meteorological forecasting systems, affecting the timeliness of the forecasts. Additionally, the high computational complexity also implies greater demands on computing resources. In resource-limited computational environments (such as embedded systems or mobile devices), the application of Lanczos filtering is constrained and may not run efficiently.

Currently, commonly used meteorological data filtering methods also include Kalman filtering, wavelet transform filtering, and others. These methods are effective in noise reduction and handling outliers, but they still face some issues in practical applications, such as high computational complexity and difficulty in parameter tuning. Therefore, a simple, efficient, and innovative improved moving average filtering method is proposed for meteorological data processing, which holds significant practical value.

### SUMMARY

In view of the shortcomings of the prior art, the objective of the present disclosure is to provide a method, medium, and device for processing meteorological data based on improved moving average filtering, aimed at improving the quality and reliability of the data.

To achieve the above objective and other related objectives, the present disclosure provides a method for processing meteorological data based on improved moving average filtering, including: collecting and cleaning original meteorological data to obtain to-be-processed meteorological data; performing weighted moving average filtering on the to-be-processed meteorological data to obtain filtered meteorological data; conducting trend analysis and boundary processing on the filtered meteorological data; and reconstructing the filtered meteorological data after being subjected to the trend analysis and boundary processing to ensure data continuity and integrity.

In one embodiment of the present disclosure, cleaning the original meteorological data to obtain the to-be-processed meteorological data includes: processing anomalous data from the original meteorological data to obtain initially cleaned data; wherein processing the anomalous data from the original meteorological data includes using a range check (also referred to as a climatological limit check in meteorological quality control, where the measured value is compared against predetermined climatological or physical limits) and a temporal consistency check; normalizing the initial cleaned data to obtain the to-be-processed meteorological data.

In one embodiment of the present disclosure, the range check includes removing data that falls outside a boundary value range. The temporal consistency check includes checking for missing data over time, imputing the missing data, verifying whether meteorological element sampling values exceed an allowable variation range within a certain time period, and removing data that exceeds the variation range.

In one embodiment of the present disclosure, performing weighted moving average filtering on the to-be-processed meteorological data to obtain the filtered meteorological data include: determining an initial sliding window; dynamically adjusting the size of the initial sliding window based on volatility and periodicity of data to form a required sliding window; assigning weights to each data point within the required sliding window; obtaining the filtered meteorological data based on the to-be-processed meteorological data and the weights.

In an embodiment of the present disclosure, a method of obtaining the filtered meteorological data based on the to-be-processed meteorological data and the weights includes:

$${y}_{t} = \frac{{\sum }_{i = t - W + 1}^{t} {ω}_{i} {x}_{i}}{{\sum }_{i = t - W + 1}^{t} {ω}_{i}} t ;$$

wherein xᵢ is the original data, ωᵢ is a weight coefficient, yᵢ is the filtered meteorological data, _{w} is the initial sliding window, t is a sequence number of data point, and i is a sequence number of data point within a sliding window.

In an embodiment of the present disclosure, a method of trend analysis includes a fitting model based on linear regression or polynomial regression.

In an embodiment of the present disclosure, a method of boundary processing includes zero-padding or mirror extension.

To achieve the above objective and other related objectives, the present disclosure further provides a device for processing meteorological data based on improved moving average filtering, comprising: data preprocessing module, configured to collect and clean original meteorological data to obtain to-be-processed meteorological data; weighted moving average filtering module, configured to perform weighted moving average filtering on the to-be-processed meteorological data to obtain filtered meteorological data; trend analysis module, configured to conduct trend analysis on the filtered meteorological data; boundary processing module, configured to conduct boundary processing on the filtered meteorological data; and reconstruction module, configured to reconstruct the filtered meteorological data after being subjected to the trend analysis and boundary processing to ensure data continuity and integrity.

To achieve the above objective and other related objectives, the present disclosure further provides a computer storage medium storing program instructions. When the program instructions are executed, the steps of the above-mentioned method for processing meteorological data based on improved moving average filtering are implemented.

To achieve the above objective and other related objectives, the present disclosure further provides an electronic device, comprising: a memory, configured to store a computer program; a processor, configured to execute the computer program to implement the steps of the above-mentioned method for processing meteorological data based on improved moving average filtering.

As described above, the method, medium, and device for processing meteorological data based on improved moving average filtering in the present disclosure have the following beneficial effects:

The present disclosure can provide higher precision and reliability in the meteorological data processing process.

### BRIEF DESCRIPTION OF THE DRAWINGS

In order to more clearly illustrate the technical solutions in the embodiments of the present disclosure, the following briefly introduces the drawings required for the description of the embodiments. Obviously, the drawings described below are merely some embodiments of the present disclosure. For those skilled in the art, other drawings may be obtained based on these drawings without any inventive efforts.

FIG. 1 is an overall schematic flowchart showing a method for processing meteorological data based on improved moving average filtering according to one embodiment of the present disclosure.

FIG. 2 is a schematic flowchart showing data preprocessing in the method for processing meteorological data based on improved moving average filtering according to one embodiment of the present disclosure.

FIG. 3 is a schematic diagram showing the principle and process of data preprocessing in the method for processing meteorological data based on improved moving average filtering according to one embodiment of the present disclosure.

FIG. 4 is a schematic diagram showing spiked data in the method for processing meteorological data based on improved moving average filtering according to one embodiment of the present disclosure.

FIG. 5 is a schematic flowchart showing obtaining filtered meteorological data using the method for processing meteorological data based on improved moving average filtering according to one embodiment of the present disclosure.

FIG. 6 is a diagram showing comparisons between different filtering methods and comparisons of data generated when using the method for processing meteorological data based on improved moving average filtering according to one embodiment of the present disclosure.

FIG. 7 is a block diagram of a device for processing meteorological data based on improved moving average filtering according to one embodiment of the present disclosure.

FIG. 8 is a block diagram of an electronic device according to one embodiment of the present disclosure.

FIG. 9a is a diagram showing a comparison of wind speed data generated using different filtering methods according to one embodiment of the present disclosure.

FIG. 9b is a diagram showing a comparison of absolute errors over time between different filtering methods according to one embodiment of the present disclosure.

FIG. 9c is a diagram showing a comparison of error distributions between different filtering methods according to one embodiment of the present disclosure.

### DETAILED DESCRIPTION

The embodiments of the present disclosure will be described below through exemplary embodiments. Those skilled in the art can easily understand other advantages and effects of the present disclosure according to the contents disclosed by the specification. This embodiment can also be implemented or applied through other different specific embodiments. Various modifications or changes can be made to all details in the specification based on different points of view and applications without departing from the spirit of the present disclosure. It should be noted that, in the case of no conflict, the following embodiments and the features in the embodiments may be combined with each other.

Filtering originated from radio technology, as radio waves are subject to interference during propagation, resulting in noise in the received signal. This can be represented by the expression y(t)=x(t)+σ(t), where y(t) is the observed value, x(t) is the useful information, and σ(t) is the noise. The technique of eliminating interference to extract useful information is known as filtering.

In the context of global climate change and the frequent occurrence of extreme weather events, the accurate acquisition and processing of meteorological data are crucial for weather forecasting and environmental monitoring. With the continuous development of meteorological observation and sensor technologies, the types and volume of meteorological data have increased dramatically. However, these data often contain substantial amounts of noise and outliers. For example, the atmosphere contains various types of waves, such as sound waves, gravity waves, inertial waves, fast waves, long waves, ultra-long waves, and slow waves. For large-scale atmospheric motion forecasting, it is essential to filter out sound waves, gravity waves, and even inertial waves. Otherwise, these fast waves, due to observational errors, may grow rapidly, leading to significant deviations in the forecast results. These fast waves, which degrade forecast accuracy, are considered noise. For different forecast valid periods and different projects, it is necessary to filter out different wave disturbances while preserving the dominant wave motions that control the relevant weather phenomena. Effective filtering and processing methods are required to extract useful information for accurate weather forecasting and climate analysis.

The significance of meteorological data filtering is mainly reflected in the following aspects:

### 1. Improving Data Accuracy:

Meteorological data often contains various interferences and noise, which can affect the accuracy of the data and lead to biased analysis results. Filtering can effectively remove noise, improve data accuracy, and ensure the reliability of subsequent analysis and forecasting.

### 2. Removing Outliers:

Due to sensor malfunctions, environmental interference, or other factors, meteorological data may contain outliers. If these outliers are not removed, they can negatively impact data analysis and model training. Filtering methods can identify and remove these outliers, thereby obtaining more accurate and realistic meteorological data.

### 3. Enhancing Data Smoothness:

The smoothness of meteorological data is crucial for capturing long-term trends and periodic changes. Filtering can eliminate short-term fluctuations, making the data smoother and thus easier to identify and analyze long-term trends.

### 4. Improving Data Continuity:

During the data collection process, there may be instances of missing data or discontinuous data. By using appropriate filtering methods, missing data can be interpolated or filled in, enhancing the continuity of the data.

### 5. Improving Data Processing Efficiency:

In the process of processing large-scale meteorological data, filtering can reduce noise and irrelevant information, simplifying the data and improving processing efficiency. This is particularly important in real-time data processing and fast-response application scenarios.

Currently, commonly used meteorological data filtering methods include Kalman filtering, wavelet transform filtering, and others. These methods are effective in denoising and handling outliers, but they still face some issues in practical applications:

1. High Computational Complexity: For example, Kalman filtering requires extensive matrix operations, and wavelet transform filtering involves complex transformation and inverse transformation processes. When handling large-scale data, these methods consume significant computational resources.

2. Difficulty in Parameter Tuning: These filtering methods often involve the selection and tuning of multiple parameters, such as the state transition matrix and measurement noise covariance matrix in Kalman filtering, or the choice of mother wavelet and decomposition levels in wavelet transform filtering. Improper parameter selection can affect the filtering performance, and the tuning process is complex.

3. Significant Boundary Effects: Boundary effects often occur at the start and end of the signal during the filtering process, leading to inaccurate processing of boundary data and introducing artifacts and distortions.

4. Limited Capability in Handling Non-Stationary Signals: Meteorological data is often non-stationary, and traditional filtering methods perform poorly when dealing with non-stationary signals. They are unable to accurately capture the dynamic change characteristics in meteorological data.

Therefore, this embodiment provides a method, medium, and device for processing meteorological data based on improved moving average filtering, which holds significant practical value. This embodiment aims to address issues in the prior art, such as boundary effects, poor denoising performance, and high computational complexity, by introducing techniques such as weighted moving average, dynamic sliding window, and trend analysis and adjustment. It offers an efficient and reliable solution for processing meteorological data.

Lanczos filtering is a digital signal processing technique widely used in fields including image processing, signal reconstruction, and data smoothing, etc. This filter is an efficient low-pass filter that removes noise by smoothing the signal in the frequency domain. The core idea of Lanczos filtering is to use the Lanczos kernel function to perform weighted average on the signal, thereby achieving the smoothing process.

The Lanczos kernel function is a type of window function used to implement filtering by convolving the signal with this kernel function. The mathematical expression of the Lanczos kernel function is as follows:

$$L ( x ) = \frac{sin ( π x ) sin ( \frac{π x}{a} )}{{( π x )}^{2}} ;$$

where a is the parameter of the filter, which determines the size of the window and the frequency response characteristics. Typically, the value of a ranges from 2 to 5.

Advantages: Good Frequency Selectivity: The Lanczos filter, through the Lanczos window function, provides good frequency selectivity, effectively reducing spectral leakage.

Good Smoothness: It can effectively remove noise while preserving the main characteristics of the signal, resulting in a smoother signal.

Disadvantages: High Computational Complexity: The Lanczos filter involves Fourier transform and window function operations, resulting in a large computational load and low efficiency when processing large-scale data. Complex Parameter Tuning: The selection and parameter setting of the window function requires experience and fine-tuning, which affects the filtering performance. Boundary Issues: When applying Lanczos filtering, the filter cannot fully cover all data points at the beginning and end of the data sequence, leading to ineffective filtering of data at the boundaries. Edge Effects: Filtered data may exhibit localized signal distortion.

Kalman filtering is a recursive filter used to estimate the state of a dynamic system. The basic idea is to update the state estimate using prior information and current measurement data, and it is mathematically expressed as follows:

### State Prediction:

$${\hat{x}}_{k \vert k - 1} = {F}_{k} {\hat{x}}_{k - 1 \vert k - 1} + {B}_{k} {u}_{k}$$

$${P}_{k \vert k - 1} = {F}_{k} {P}_{k - 1 \vert k - 1} {F}_{k}^{T} + {Q}_{k}$$

### Kalman Gain:

$${K}_{k} = {P}_{k \vert k - 1} {{H}_{k}^{T} ( {H}_{k} {P}_{k \vert k - 1} {H}_{k}^{T} + {R}_{k} )}^{- 1}$$

### State Update:

\hat{x}_{k|k}=\hat{x}_{k|k-1}+Kₖ(zₖ−Hₖ\hat{x}_{k|k-1})

P_{k|k}=(I−KₖHₖ)P_{k|k-1}
where \hat{x}_{k|k-1} is the state prediction at time k, P_{k|k-1} is the prediction error covariance matrix, Kₖ is the Kalman gain, zₖ is the measurement value, Fₖ is the state transition matrix, Bₖ is the control input matrix, uₖ is the control input, Hₖ is the measurement matrix, Qₖ is the process noise covariance matrix, and Rₖ is the measurement noise covariance matrix.

Advantages: Good Dynamics: Kalman filtering can update state estimates in real-time, making it suitable for handling dynamically changing data. Strong Noise Handling Capability: By modeling both system noise and measurement noise, it effectively filters out noise, improving estimation accuracy. High Adaptability: It can handle multidimensional data and complex systems, providing strong adaptability.

Disadvantages: High Computational Complexity: It involves matrix operation and matrix inversion, resulting in a large computational load, especially low efficiency in high-dimensional systems. Complex Parameter Setting: Accurate noise statistics and system models are needed; therefore, improper parameter settings can lead to poor filtering performance. Sensitivity to Linear Assumptions: Kalman filtering assumes that the system is linear. For nonlinear systems, the Extended Kalman Filtering (EKF) or Unscented Kalman Filtering (UKF) is required, which introduces higher complexity.

Wavelet transform filtering uses wavelet transforms to decompose the signal into different scales, processes the coefficients at each scale, and then reconstructs the signal using the inverse wavelet transform, thereby achieving the filtering effect. This can be mathematically expressed as:

### Discrete Wavelet Transform (DWT):

$${c}_{j , k} = {\int }_{- ∞}^{∞} x ( t ) {φ}_{j , k} ( t ) dt .$$

Threshold Processing (Denoising): It is assumed that the threshold value is 2, and thresholding is performed on the wavelet coefficient c_{j,k}: ĉ_{j,k}=sgn(c_{j,k})·max(|c_{j,k}|−λ, 0).

Inverse Discrete Wavelet Transform (IDWT): x(t)=ΣⱼΣₖĉ_{j,k}φ_{j,k}(t).

By following the above steps, performing thresholding on the wavelet coefficients as described above, and then reconstructing the signal, the filtering effect can be achieved.

Advantages: Multiscale Analysis: It allows for signal analysis in both the time and frequency domains simultaneously, making it suitable for processing non-stationary signals. Good Denoising Performance: Wavelet transform filtering can remove noise at different scales while preserving the main characteristics of the signal. High Flexibility: Different wavelet basis functions and decomposition levels can adapt to various types of signals and application requirements.

Disadvantages: High Computational Complexity: The wavelet transform and inverse transform processes are complex, resulting in a large computational load and low efficiency when processing large-scale data. Significant Boundary Effects: Wavelet transform is prone to introducing artifacts and distortions in boundary processing, requiring special boundary processing strategies. Complex Parameter Tuning: The selection of the wavelet basis function and the setting of the decomposition levels require experience and fine-tuning, which significantly affects the filtering performance.

The method for processing meteorological data based on improved moving average filtering provided in this embodiment has significant advantages in terms of reduction in computational complexity, ease of implementation and tuning, and improvement in boundary effect processing, adaptability to non-stationary signals, denoising performance, as well as real-time processing capability. As a result, this embodiment is more suitable for real-time processing and fast-response applications of large-scale meteorological data, providing an efficient and reliable solution for processing meteorological data.

The following provides a detailed explanation of the principles and implementation methods of the method, medium, and device for processing meteorological data based on improved moving average filtering. This aims to enable those skilled in the art to understand the method, medium, and device for processing meteorological data based on improved moving average filtering in this embodiment without requiring any inventive effort.

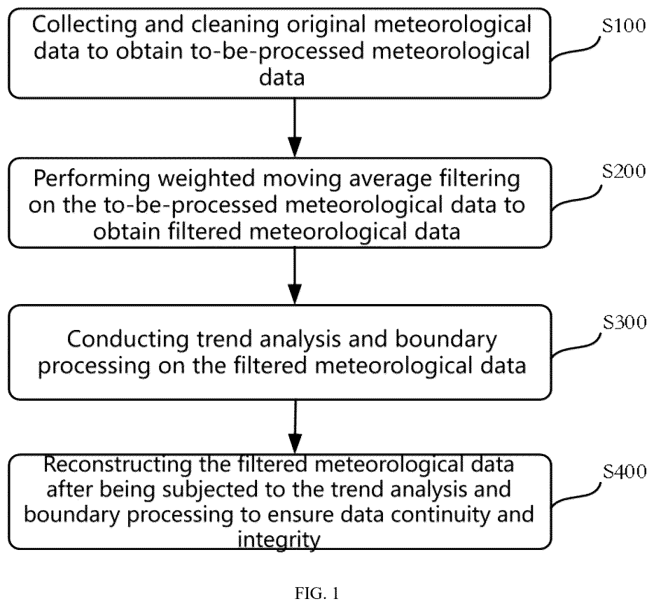

This embodiment provides a method for processing meteorological data based on improved moving average filtering. Specifically, as shown in FIG. 1, the method for processing meteorological data based on improved moving average filtering in this embodiment includes:
Step S100, collecting and cleaning original meteorological data to obtain to-be-processed meteorological data;
Step S200, performing weighted moving average filtering on the to-be-processed meteorological data to obtain filtered meteorological data;
Step S300, conducting trend analysis and boundary processing on the filtered meteorological data;
Step S400, reconstructing the filtered meteorological data after being subjected to the trend analysis and boundary processing to ensure data continuity and integrity.

The following provides a detailed explanation of the above-mentioned steps S100 to S400 in the method for processing meteorological data based on improved moving average filtering in this embodiment.

Step S100, collecting and cleaning original meteorological data to obtain to-be-processed meteorological data.

FIG. 2 is a schematic diagram showing data preprocessing in the method for processing meteorological data based on improved moving average filtering according to one embodiment of the present disclosure. As shown in FIG. 2, in an embodiment of the present disclosure, cleaning the original meteorological data to obtain the to-be-processed meteorological data includes the following steps S110 to S120.

Step S110, processing anomalous data from the original meteorological data to obtain initially cleaned data; wherein processing the anomalous data from the original meteorological data includes range check and temporal consistency check.

step S120, normalizing the initially cleaned data to obtain to-be-processed meteorological data.

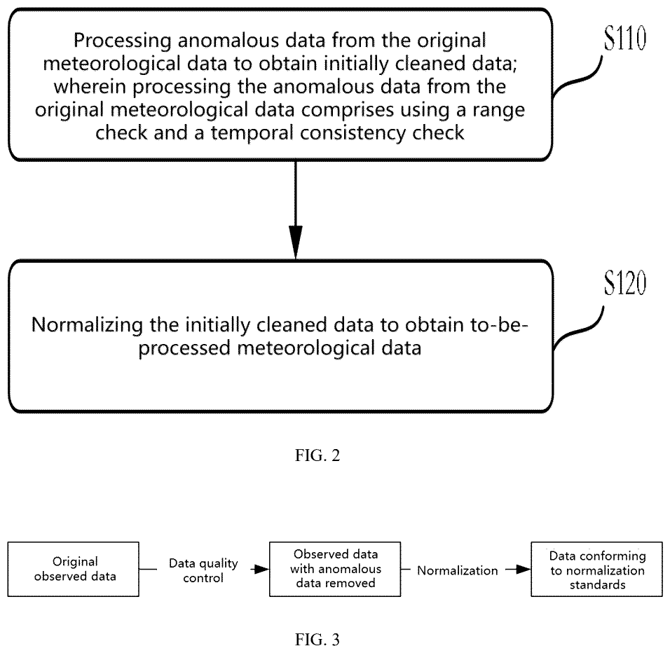

FIG. 3 is a schematic diagram showing the principle and process of data preprocessing in the method for processing meteorological data based on improved moving average filtering according to one embodiment of the present disclosure. The original meteorological data required for filtering are collected; however, the original observed data may contain missing values and other issues. To improve data quality, enhance data value, reduce redundancy, and accelerate data analysis, the original data is cleaned in this embodiment. The specific process includes data quality control (i.e., processing the anomalous data from the original meteorological data to obtain initially cleaned data) and data normalization.

Specifically, in an embodiment of the present disclosure, the range check includes removing data that falls outside the range. The temporal consistency check includes checking for missing data over time, imputing the missing data, verifying whether meteorological element sampling values exceed the allowable variation range within a certain time period, and removing data that exceeds the variation range.

Meteorological data often contain errors during the observation process. Based on the nature and causes of these errors, observed meteorological data may exhibit three types of errors: random errors (with a mean of zero), systematic errors (with a non-zero mean, mainly due to habitual mistakes, instrument biases, etc.), and gross errors (arising from observation, calculation, transmission, etc.). Random errors are primarily mitigated through repeated sampling, while data quality control focuses mainly on reducing the impact of the latter two types of errors.

Specifically, in one embodiment, the range check includes a climatological range check, categorized based on the nature. Data that falls outside the range is regarded as anomalous. The setting of the upper limit value of the range significantly affects the effectiveness of the range check. If the upper limit is set too high, anomalous data may be mistakenly considered as correct data, potentially leading to the use of anomalous data in applications. Conversely, if the upper limit is set too low, some valid data with slightly higher values may be incorrectly classified as anomalous data; however, the valid data is particularly valuable for researching extreme weather events and issuing meteorological early warnings.

The temporal consistency check includes a time continuity check and a meteorological element characteristic check. The time continuity check primarily verifies whether there are any missing data over time and ensures that the missing data is properly handled.

When the amount of missing data is small, it may be appropriate to remove the records containing missing values. This approach is suitable when the proportion of missing data is low and the remaining dataset is sufficiently large. However, if a high proportion of missing data occurs for a particular variable, it may be advisable to eliminate the entire variable. This approach is typically suitable when the variable has little impact on the analysis results.

In this embodiment, missing values can also be imputed, using methods that include, but are not limited to: constant value imputation, interpolation, and model-based prediction.

Constant value imputation involves imputing missing values with a fixed value, such as the mean, median, or mode of the dataset. This method is simple and computationally efficient, but it may introduce bias, particularly when the imputed value significantly deviates from the true value. Interpolation methods, such as linear interpolation or polynomial interpolation, involve fitting the existing data to estimate and impute the missing values. While this method captures underlying data trends, it can be computationally intensive and may lack accuracy in the presence of large fluctuations in the data. Model-based prediction leverages other complete data to build models, such as linear regression, decision trees, or KNN, to predict and impute the missing values. This method effectively utilizes the correlations between data, but it requires substantial computational resources. Additionally, the choice of the model and its accuracy significantly impact the quality of the imputation.

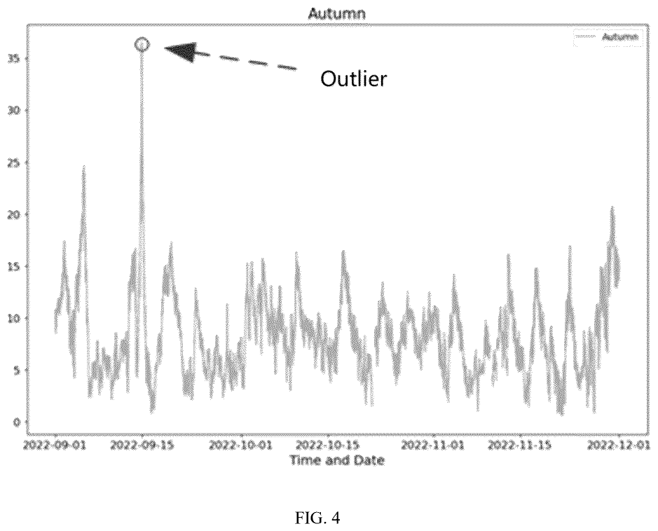

The meteorological element characteristic check is based on the principle that the meteorological elements typically follow regular patterns over time and do not exhibit abrupt changes within relatively short periods. It is a method to verify whether the meteorological elements conform to these expected patterns. If the sampling values of meteorological elements exceed the allowable variation range within a certain time period, they are flagged as anomalous data. FIG. 4 is a schematic diagram showing spiked data in the method for processing meteorological data based on improved moving average filtering according to an embodiment of the present disclosure. The circled data in FIG. 4 represents anomalous data that should be excluded from the dataset.

Since meteorological variables fluctuate widely across an entire year, using original data without adjustment can result in significant errors in calculation and evaluation. Data normalization refers to scaling data proportionally so that data values with different original ranges are transformed into a common range. It is commonly used in the processing of comparison and evaluation indicators to eliminate discrepancies in units and magnitudes, transforming the data into dimensionless pure numerical values. This facilitates the comparison and weighting of indicators with different units and magnitudes.

Data normalization not only unifies the scales as well as smooths the gradients across different batches and layers of data, but also prevents model gradient explosion or vanishing. After data normalization, the “gradient gap” in the original data is reduced globally, effectively preventing significant oscillations in data within a certain layer in the model and achieving the effect of smoothing gradients. In this embodiment, min-max normalization is adopted, with the formula as follows:

$${x}_{normalized} = \frac{{x}_{original} - min}{max - min} .$$

Step S200, performing weighted moving average filtering on the to-be-processed meteorological data to obtain filtered meteorological data.

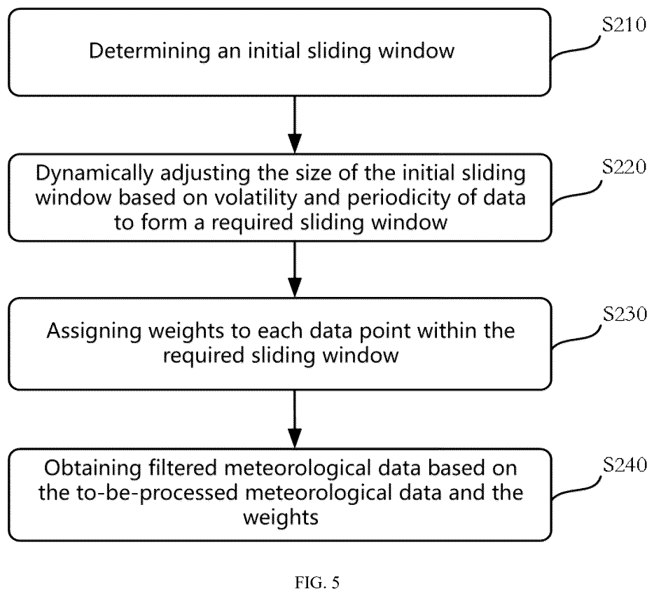

In this embodiment, original meteorological data is cleaned to obtain the to-be-processed meteorological data. Subsequently, weighted moving average filtering is performed on the to-be-processed meteorological data to obtain filtered meteorological data. Specifically, the filtered meteorological data is obtained by defining the size of the sliding window and performing weighted moving average filtering on the data. FIG. 5 is a schematic flowchart of obtaining filtered meteorological data using the method for processing meteorological data based on improved moving average filtering according to one embodiment of the present disclosure. As shown in FIG. 5, in an embodiment of the present disclosure, performing weighted moving average filtering on the to-be-processed meteorological data to obtain filtered meteorological data includes the following steps S210 to S240.

Step S210, determining an initial sliding window.

The initial sliding window W can be determined based on the characteristics of the meteorological data and specific processing requirements.

Step S220, dynamically adjusting the size of the initial sliding window based on the volatility and periodicity of data to form a required sliding window.

In this embodiment, the size of the sliding window is dynamically adjusted to better accommodate the volatility and periodicity of data. For example, the window is narrowed when data is highly volatile, and it is expanded when data is relatively stable.

Step S230, assigning weights to each data point within the required sliding window.

In this embodiment, a weight ωi is assigned to each data point within the sliding window. The weight can be set based on factors such as the temporal position of each data point and the magnitude of the data value.

Step S240, obtaining filtered meteorological data based on the to-be-processed meteorological data and the weights.

In an embodiment of the present disclosure, the method of obtaining the filtered meteorological data based on the to-be-processed meteorological data and the weights includes:

$${y}_{t} = \frac{{\sum }_{i = t - W + 1}^{t} {ω}_{i} {x}_{i}}{{\sum }_{i = t - W + 1}^{t} {ω}_{i}} t ;$$

wherein xᵢ is the to-be-processed meteorological data (cleaned data), ωᵢ is the weight coefficient, yᵢ is the filtered meteorological data, _{w} is the initial sliding window, t is the sequence number of the data point, and i is the sequence number of each data point within the sliding window.

Step S300, conducting trend analysis and boundary processing on the filtered meteorological data.

In an embodiment of the present disclosure, the method of trend analysis includes a fitting model based on linear regression or polynomial regression.

In this embodiment, the filtered results are adjusted through trend analysis:

In this embodiment, trend analysis is performed on the filtered meteorological data. Linear regression, polynomial regression, or other appropriate fitting models are employed to determine the trend of the weighted moving average filtered results. For example, it is assumed that the fitting model is denoted as T(t), which represents the overall trend of the data.

Residual calculation: The residuals between the results of the initially weighted moving average filtering with the fitting model are computed, denoted as r (t)=yt−T(t), where yt represents the initially filtered data. This step involves contrasting the results of the initially filtered data with those of the trend line to quantify the difference, thereby revealing high-frequency fluctuations and noise within the data.

Residual adjustment: The residuals are smoothed to mitigate the influence of high-frequency noise, resulting in a smoothed residual rs(t).

Data reconstruction: the smoothed residual is added to the fitting model to obtain the adjusted data: yt2=T(t)+rs(t), ensuring the adjusted data more accurately reflects the trend and variation in the original data.

Based on these analysis results, the filtered results are further adjusted to better capture the trend changes in the data. For instance, the weight coefficients are adjusted to enhance the trend signals and diminish the impact of noise.

In one embodiment of the present disclosure, the method of boundary processing includes zero-padding or mirror extension.

In this embodiment, boundary effects are reduced by processing data boundaries (data points at the beginning and end of the data sequence). For example, strategies such as zero-padding or mirror extension are employed to process data boundaries, thereby mitigating boundary effects.

Zero-padding involves imputing zeros at both ends of the data sequence to extend the length of the data sequence. Mirror extension appends the mirrored portion of the original data sequence at both ends to extend the length of the data sequence.

A weighted moving average calculation is performed on the data after boundary processing, ensuring accurate handling of the boundary data.

Step S400, reconstructing the filtered meteorological data after being subjected to the trend analysis and boundary processing to ensure data continuity and integrity.

In this embodiment, the filtered data after being subjected to the trend analysis and boundary processing is reconstructed to ensure the continuity and integrity of the data.

Specifically, the filtered data after being subjected to the trend adjustment and boundary processing is reconstructed to ensure the continuity and integrity of the data. Additionally, the reconstructed data can be verified and validated to check for the presence of outliers or discontinuities. Finally, the processed data is stored in a database for subsequent analysis and prediction.

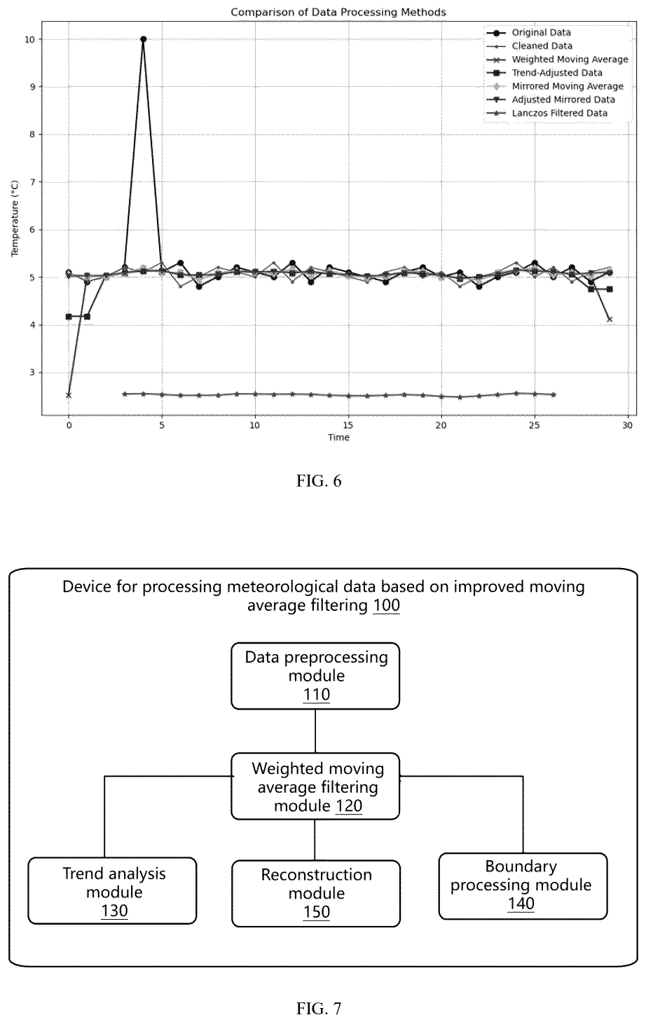

Based on the above steps, filtering was performed on the temperature data of a certain location over one month. The results are shown in FIG. 6: FIG. 6 is a diagram showing comparisons between different filtering methods and comparisons of data generated when using the method for processing meteorological data based on improved moving average filtering according to one embodiment of the present disclosure. FIG. 6 displays the original data (i.e., original meteorological data), the data after weighted moving average filtering (i.e., filtered meteorological data), and the data after trend analysis, mirror extension, and adjustment. Below is an explanation of each curve:

Original Data (Blue Curve): Noise and outliers are contained.

Cleaned Data (Green Curve): The original meteorological data after cleaning is shown, where obvious outliers (e.g., 10.0° C.) are removed.

Weighted Moving Data (Red Curve): The weighted moving average filtering is performed, smoothing the cleaned data (to-be-processed meteorological data) and reducing some noise.

Trend-Adjusted Data (Purple Curve): Based on weighted moving average filtering, the filtered results are further adjusted using trend analysis methods to better capture trend changes, resulting in smoother and more continuous results.

Mirrored Moving Average (Orange Curve): Boundary data (i.e., data points at the beginning and end of the data sequence) is handled, and boundary effects are reduced.

Adjusted Mirrored Data (Brown Curve): The final data obtained after both trend analysis and boundary processing, providing the smoothest and most reliable results.

Lanczos Filtered Data (Pink Curve): It can be seen that boundary data is set as missing values due to the limitations of the filter.

### Specific Comparison:

Data Smoothing and Trend Preservation: Both Lanczos filtering and weighted moving average filtering can smooth data and remove high-frequency noise. However, by combining weighted moving average filtering with trend analysis and adjustment, this embodiment can better capture trend changes in data.

Boundary Processing: Lanczos filtering tends to cause data loss at the boundaries, resulting in missing values. In contrast, this embodiment effectively resolves the issue of boundary effects through techniques such as mirror extension and trend adjustment, ensuring the continuity of data.

Frequency Response: Lanczos filtering exhibits a well-defined band-pass characteristic, primarily targeting low-frequency components. However, the weighted moving average filtering of this embodiment can flexibly adapt to different frequency components by adjusting the weights, offering a more versatile frequency response.

In terms of frequency characteristics, both Lanczos filtering and the weighted moving average filtering of this embodiment share a degree of consistency in smoothing data and removing high-frequency noise. However, by integrating weighted moving average filtering with trend analysis and boundary processing methods, this embodiment more effectively addresses the issue of boundary effects, ensuring the continuity and integrity of data, thereby achieving better effects in practical applications. Therefore, this embodiment demonstrates superior advantages in overall filtering performance and boundary processing.

By adopting the method for processing meteorological data based on improved moving average filtering in this embodiment, noise and outliers in meteorological data can be effectively removed, thereby enhancing data quality and reliability. This method introduces innovative improvements on the basis of the traditional moving average filtering, including weighted moving average, dynamic sliding window, and trend-analysis adjustment. It overcomes issues in the prior art such as boundary effects and poor denoising performance, while maintaining low computational complexity and ease of implementation. It is well suited for real-time processing of large-scale meteorological data and can be widely applied in meteorological data processing, weather forecasting, disaster early warning, and environmental monitoring.

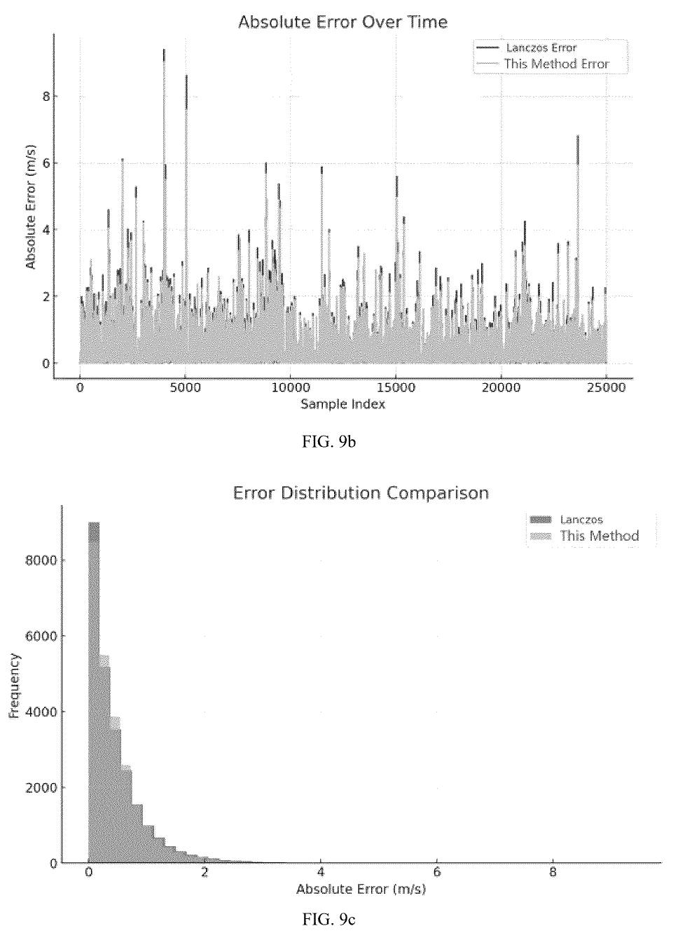

In the aforementioned embodiment, the present disclosure takes temperature data as an example to illustrate the procedure and effect of the method for processing meteorological data based on improved moving average filtering. To further verify the adaptability of this method to other types of meteorological elements, particularly wind speed data, which exhibits high-frequency fluctuations and strong abrupt changes, the present disclosure further provides an example involving the processing of 10-meter wind speed data from a local lidar system. The dataset has a sampling frequency of once every 10 minutes, covering the period from 00:00 on May 11, 2021 to 03:40 on Nov. 5, 2022, including a total of 78,215 time points. The dataset contains evident spikes, outliers, and short-period disturbances. Filtering was performed using both the Lanczos filtering and the method of the present disclosure. The results are shown in FIG. 9. FIG. 9a shows three curves, i.e., the cleaned data (original wind speed data after cleaning), the data obtained using the Lanczos, and the data obtained using the method of the present disclosure. FIGS. 9b and 9c show a comparison of the absolute errors over time (only the first 25,000 samples are shown due to the large sample size) and a comparison of error distributions, respectively.

The objective of wind speed data filtering is to effectively suppress unstructured noise caused by radar mismeasurement, abrupt disturbances, and high-frequency jitter, while preserving the genuine meteorological trends and physical variation structures as much as possible.

As shown in the comparison of absolute errors over time (FIG. 9b), in the entire dataset, the method of the present disclosure exhibits smaller error peaks in multiple segments with abrupt changes (e.g., around sample points of 5,000, 12,000, and 16,000), whereas the Lanczos filtering method shows pronounced delays or oscillations.

As shown in the comparison of error distributions (FIG. 9c), the errors of the method of the present disclosure are more concentrated within the range of 0-0.5 m/s and occur significantly less frequently when the wind speed is more than 1.5 m/s, compared to those of the Lanczos filtering method. This indicates that the method of the present disclosure is more robust for the majority of sample data and has a stronger capability to suppress abnormal disturbances.

To further compare the overall error levels and extreme error suppression capabilities of the two methods (i.e., Lanczos and the method in the present disclosure), error statistic indicators (Table 1) and quantile errors (Table 2) are introduced.

TABLE 1
Error Statistical Indicators

| Indicators | Lanczos | This Method |
|---|---|---|
| MSE(m²/s²) | 0.4016 | 0.3391 |
| RMSE(m/s) | 0.6338 | 0.5823 |
| MAE(m/s) | 0.4215 | 0.4007 |
| Correlation Coefficient | 0.9795 | 0.9828 |

The quantitative indicators in Table 1 show that the method of the present disclosure outperforms the Lanczos filtering method in MSE, RMSE, and MAE, demonstrating superior overall filtering accuracy and robustness. Moreover, its correlation coefficient is slightly higher than that of the Lanczos filtering method, indicating better preservation of the original wind speed variation trends while denoising.

TABLE 2
Quantile Errors

| Quantile | Errors of Lanczos (m/s) | Errors of This Method (m/s) |
|---|---|---|
| 50% (Median) | 0.3057 | 0.3058 |
| 90% | 1.0814 | 0.9783 |
| 99% | 2.4827 | 2.1837 |

The method of the present disclosure limits the maximum error for 90% of sample points to within 0.98 m/s, which is approximately 9.5% lower than that of the Lanczos filtering method. For the most extreme 1% of sample points, the maximum error is reduced by approximately 12% compared to the Lanczos filtering method, indicating the method of the present disclosure exhibits better robustness.

In summary, at the outlier points, the filtered results of the present disclosure are more stable and do not exhibit the error oscillations seen in the Lanczos filtering method. In terms of overall trends, the correlation of the present disclosure is higher (0.9828 vs. 0.9795), indicating closer adherence to the original trends. The method of the present disclosure has substantially reduced high-quantile errors (90% and 99% of sample points), demonstrating superior control over extreme disturbances. Besides, the error distribution of the method of the present disclosure is more concentrated, and the noise suppression effect is more significant.

The beneficial effects of this embodiment are reflected in the following aspects:

1. Effective noise and outlier removal: Through the use of weighted moving average filtering and dynamic sliding window techniques, noise and outliers in meteorological data can be more accurately filtered out. Compared with traditional Kalman filtering and wavelet transform filtering methods, the filtering method of this embodiment achieves more significant denoising performance, particularly when handling anomalous data introduced by sensor faults or environmental interference.

2. Reduced boundary effects: By adopting specific boundary processing strategies (such as zero padding and mirror extension), this method effectively reduces signal distortion caused by boundary effects during filtering, ensuring smoothness and continuity of the filtered results and improving the accuracy of meteorological data processing.

3. Improved computational efficiency: While retaining the simplicity of calculation in moving average filtering, this method of this embodiment optimizes the calculation process through weighted processing and dynamic adjustment of the sliding window size. It achieves efficient denoising while maintaining low computational complexity, making it suitable for real-time processing of large-scale meteorological data and highly practical in applications.

4. Enhanced trend capture capability: By integrating trend analysis methods to further adjust the filtered results, this method better captures trend variations in meteorological data, improving data analysis and forecasting capabilities and supporting applications such as weather prediction, disaster early warning, and environmental monitoring.

5. Adaptability to multi-source data: The method of this embodiment can process meteorological data collected from multiple sources, including weather stations, satellites, radars, and sensors. It has a broad range of applicability and delivers consistently excellent performance across different data sources and application scenarios.

It can be seen that this embodiment provides an efficient method for processing meteorological data. Through steps such as weighted moving average filtering, trend analysis and adjustment, boundary processing, and data reconstruction, it significantly improves the smoothness and accuracy of the data. This method addresses the issues of boundary effects and data loss in the prior art and is applicable to various meteorological data analysis and prediction scenarios.

This embodiment further provides a device for processing meteorological data based on improved moving average filtering. FIG. 7 is a block diagram of a device for processing meteorological data based on improved moving average filtering in one embodiment of the present disclosure. As shown in FIG. 7, the device for processing meteorological data based on improved moving average filtering in this embodiment includes: a data preprocessing module, a weighted moving average filtering module, a trend analysis module, a boundary processing module, and a reconstruction module.

Specifically, the data preprocessing module is configured to collect and clean original meteorological data to obtain the to-be-processed meteorological data. The data preprocessing module removes obvious outliers and handles missing values by cleaning and normalizing the collected original data. The weighted moving average filtering module is configured to perform weighted moving average filtering on the to-be-processed meteorological data to obtain filtered meteorological data. The weighted moving average filtering module defines the size of the sliding window and performs weighted moving average filtering on the data. The trend analysis module is configured to conduct trend analysis on the filtered meteorological data. The trend analysis module uses trend analysis methods to further adjust the filtering results, thereby better capturing the trend changes in data. The boundary processing module is configured to conduct boundary processing on the filtered meteorological data to reduce boundary effects. The reconstruction module is configured to reconstruct the filtered meteorological data after being subjected to the trend analysis and boundary processing to ensure the data continuity and integrity.

In this embodiment, the implementation principles of each module in the device for processing meteorological data based on improved moving average filtering are the same as those of each step in the aforementioned method for processing meteorological data based on improved moving average filtering. The implementation principles and specific implementation methods of the device for processing meteorological data based on improved moving average filtering will not be repeated herein.

This embodiment of the present disclosure further provides a computer-readable storage medium storing a computer program. When the computer program is executed by a processor, the method for processing meteorological data based on improved moving average filtering provided by any embodiment of the present disclosure is implemented.

In the embodiments of the present disclosure, any combination of one or more storage media may be adopted. The storage medium may be a computer-readable signal medium or a computer-readable storage medium. The computer-readable storage medium may be, for example, but not limited to, a system, device, or apparatus that is electrical, magnetic, optical, electromagnetic, infrared, or semiconductor-based, or any combination thereof. More specific examples (non-exhaustive) of computer-readable storage media include: electrical connections having one or more conductors, portable computer disks, hard disks, RAM, ROM, erasable programmable read-only memory (EPROM) or flash memory, optical fibers, portable compact disc read-only memory (CD-ROM), optical storage devices, magnetic storage devices, or any suitable combination of the foregoing. As used herein, a computer-readable storage medium may be any tangible medium that contains or stores a program, which can be used by, or in conjunction with, an instruction execution system, device, or apparatus.

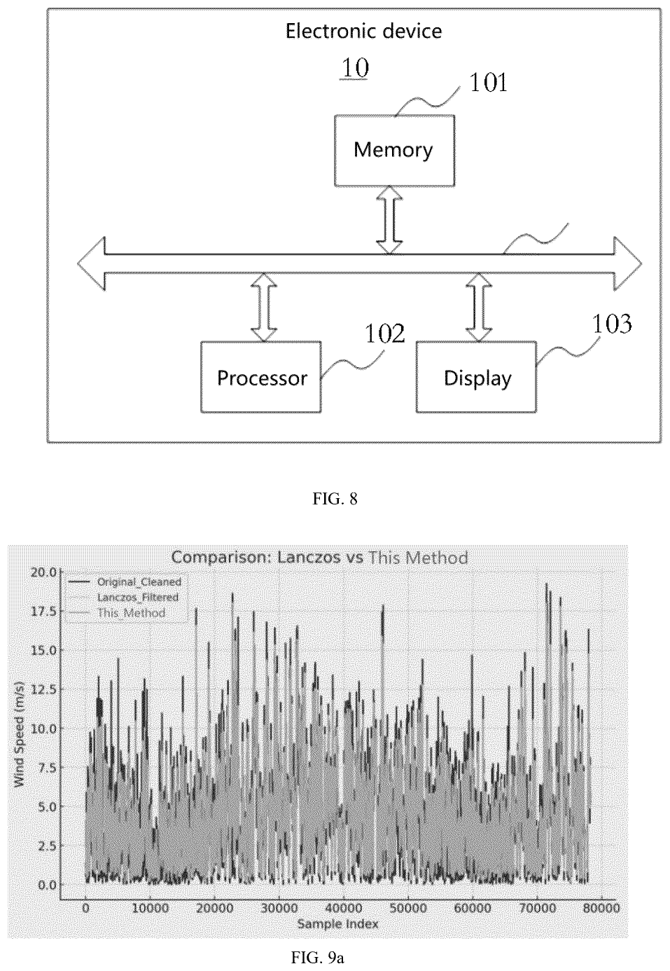

This embodiment of the present disclosure further provides an electronic device. FIG. 8 is a schematic structural diagram of an electronic device 10 according to an embodiment of the present disclosure. In certain embodiments, the electronic device 10 may be a mobile phone, tablet computer, wearable device, in-vehicle device, augmented reality (AR)/virtual reality (VR) device, notebook computer, ultra-mobile personal computer (UMPC), netbook, personal digital assistant (PDA), or other terminal devices. In addition, the method for processing meteorological data based on improved moving average filtering provided by the present disclosure may also be applied to databases, servers, and service response systems based on terminal artificial intelligence. The specific application scenarios for the method described in this embodiment of the present disclosure are not limited.

As shown in FIG. 8, the electronic device 10 provided by this embodiment in the present disclosure includes a memory 101 and a processor 102.

The memory 101 is configured to cache computer programs; preferably, the memory 101 includes ROM, RAM, magnetic disks, USB drives, cache cards, optical discs, or other media capable of storing program code.

Specifically, the memory 101 may include computer system-readable media in the form of volatile memory, such as random access memory (RAM) and/or cache memory. The electronic device 10 may further include other removable/non-removable, volatile/non-volatile computer system storage media. The memory 101 may include at least one program product having a set of (e.g., at least one) program modules, where the program modules are configured to perform the functions of the various embodiments of the present disclosure.

The processor 102 is coupled to the memory 101 and is configured to execute the computer programs stored in the memory 101, so as to enable the electronic device 10 to perform the method for processing meteorological data based on improved moving average filtering provided by any embodiment of the present disclosure.

Optionally, the processor 102 may be a general-purpose processor, including but not limited to a central processing unit (CPU) or a network processor (NP). The processor 102 may also be a digital signal processor (DSP), an application specific integrated circuit (ASIC), a field programmable gate array (FPGA), or other programmable logic device, discrete gate or transistor logic device, or discrete hardware component.

Optionally, the electronic device 10 in this embodiment may further include a display 103. The display 103 is communicatively connected to the memory 101 and the processor 102, and is configured to display a related GUI interaction interface of the meteorological data processing method based on improved moving average filtering.

Furthermore, the electronic device 10 may also include other components such as a firewall, a load balancer, a communication component, and a power component. Only a portion of the components are schematically shown in FIG. 8, and it should not be construed that the electronic device includes only the components shown in FIG. 8.

The above embodiments may be implemented in whole or in part through software, hardware, firmware, or any combination thereof. When implemented in software, the above embodiments may be realized, in whole or in part, in the form of a computer program product. The computer program product includes multiple computer instructions. When the computer program instructions are loaded onto or executed by a computer, the computer will, in whole or in part, execute the processes of this embodiment and implement the corresponding functions. The computer may be a general-purpose computer, a dedicated computer, a computer network, or other programmable device. The computer instructions may be stored on a computer-readable storage medium or transmitted from one computer-readable storage medium to another.

In summary, the method for processing meteorological data based on improved moving average filtering provided by this embodiment integrates multiple techniques, such as weighted moving average filtering, trend analysis and adjustment, and boundary processing, to overcome the respective shortcomings of Lanczos filtering, Wavelet transform filtering, and Kalman filtering when processing meteorological data. The method of the present disclosure offers the following notable advantages:

1) Boundary Effect Handling: It effectively resolves the issue of boundary effects in data, ensuring continuity and integrity of data.

2) Simplicity in Computation: It features low computational complexity, making it suitable for real-time processing applications.

3) Flexible Adaptability: By adjusting weights and window sizes, it can accommodate different frequency components and data characteristics.

4) High Robustness: It exhibits significant effectiveness in handling noise and anomalous data, providing strong robustness.

With these advantages, this embodiment delivers higher accuracy and reliability in meteorological data processing. Therefore, the present disclosure effectively overcomes the shortcomings in the prior art and offers substantial industrial applicability.

The above-mentioned embodiments are merely illustrative of the principle and effects of the present disclosure instead of limiting the present disclosure. Modifications or variations of the above-described embodiments may be made by those skilled in the art without departing from the spirit and scope of the disclosure. Therefore, all equivalent modifications or changes made by those skilled in the art without departing from the spirit and technical concept disclosed by the present disclosure shall still be covered by the claims of the present disclosure.

What is claimed is:

1. A method for processing meteorological data based on improved moving average filtering, comprising:
collecting and cleaning original meteorological data to obtain to-be-processed meteorological data;
performing weighted moving average filtering on the to-be-processed meteorological data to obtain filtered meteorological data;
conducting trend analysis and boundary processing on the filtered meteorological data; and
reconstructing the filtered meteorological data after being subjected to the trend analysis and boundary processing to ensure data continuity and integrity.

2. The method for processing meteorological data based on improved moving average filtering according to claim 1, wherein cleaning the original meteorological data to obtain the to-be-processed meteorological data comprises:
processing anomalous data from the original meteorological data to obtain initially cleaned data; wherein processing the anomalous data from the original meteorological data comprises using a range check and a temporal consistency check;
normalizing the initially cleaned data to obtain the to-be-processed meteorological data.

3. The method for processing meteorological data based on improved moving average filtering according to claim 2, wherein the range check comprises removing data that falls outside a boundary value range;
wherein the temporal consistency check comprises checking for missing data over time, imputing the missing data, verifying whether meteorological element sampling values exceed an allowable variation range within a certain time period, and removing data that exceeds the variation range.

4. The method for processing meteorological data based on improved moving average filtering according to claim 3, wherein performing weighted moving average filtering on the to-be-processed meteorological data to obtain the filtered meteorological data comprises:
determining an initial sliding window;
dynamically adjusting the size of the initial sliding window based on volatility and periodicity of data to form a required sliding window;
assigning weights to each data point within the required sliding window;
obtaining the filtered meteorological data based on the to-be-processed meteorological data and the weights.

5. The method for processing meteorological data based on improved moving average filtering according to claim 4, wherein a method of obtaining the filtered meteorological data based on the to-be-processed meteorological data and the weights comprises:
$${y}_{t} = \frac{{\sum }_{i = t - W + 1}^{t} {ω}_{i} {x}_{i}}{{\sum }_{i = t - W + 1}^{t} {ω}_{i}} t ;$$
wherein xᵢ is the original data, ωᵢ is a weight coefficient, yᵢ is the filtered meteorological data, _{w} is the initial sliding window, t is a sequence number of data point, and i is a sequence number of data point within a sliding window.

6. The method for processing meteorological data based on improved moving average filtering according to claim 1, wherein a method of trend analysis comprises a fitting model based on linear regression or polynomial regression.

7. The method for processing meteorological data based on improved moving average filtering according to claim 1, wherein a method of boundary processing comprises zero padding or mirror extension.

8. A device for processing meteorological data based on improved moving average filtering, comprising:
data preprocessing module, configured to collect and clean original meteorological data to obtain to-be-processed meteorological data;
weighted moving average filtering module, configured to perform weighted moving average filtering on the to-be-processed meteorological data to obtain filtered meteorological data;
trend analysis module, configured to conduct trend analysis on the filtered meteorological data;
boundary processing module, configured to conduct boundary processing on the filtered meteorological data; and
reconstruction module, configured to reconstruct the filtered meteorological data after being subjected to the trend analysis and boundary processing to ensure data continuity and integrity.

9. An electronic device, comprising: a memory, configured to store a computer program; a processor, configured to execute the computer program to implement the steps of the method for processing meteorological data based on improved moving average filtering according to claim 1.

10. A computer storage medium, storing program instructions therein, wherein when the program instructions are executed, the steps of the method for processing meteorological data based on improved moving average filtering according to claim 1 are implemented.
